(19) United States
(12) Patent Application Publication
(10) Pub. No.: US 2004/0211771 A1
(43) Pub. Date: Oct. 28, 2004

(54) Compacted cartridge heating element with a substantially polygonal cross section

(76) Inventor: Walter Crandell, Geneva, IL (US)

Correspondence Address: Martin Faier, Faier & Faier, P.C., 566 W. Adams St. #600, Chicago, IL, 60661, US

(21) Appl. No.: 10/423,272

(22) Filed: Apr. 25, 2003

(51) Int. Cl. H05B 3/44

(52) U.S. Cl. 219/544

(57) ABSTRACT

The present invention provides a swaged cartridge heating element with a substantially polygonal cross-section. The present invention also provides a method for making such a cartridge. In one embodiment, the cross-section is a square or a rectangular cross-section. In another embodiment the square or rectangular cartridges are bent into other heating configurations.

### FIELD OF THE INVENTION

The present invention provides a compacted cartridge heating element having a flat side, such as a substantially polygonal (e.g. rectangular, square, etc.) cross-section, a method for making the same, and methods for using the same.

### BACKGROUND

Various different types of heating elements are used for various high temperature applications, such as heating platens, sealing bars, heating fluids, hot stamping, forming dies, etc. Some examples of heating elements include tubular heaters, cartridge heaters, strip heaters, band heaters, ring heaters, plate heaters, cable heaters and cast heaters.

Cartridge heating elements are well-known, and are generally classified into two basic types, depending on construction and operational wattage capacities (a function of watts per square inch of heater surface area versus temperature). Cartridge heaters rated for high watt density applications (high density cartridges) are designed to withstand a combination of high watt densities, high heated material temperatures and high internal temperatures. The high density cartridge construction transfers heat very efficiently from the internal wire to the cartridge sheath allowing it to be used to heat metal parts in a watt density of between 0 to about 300 watts per square inch of heater surface area (depending on the fit of the heater in the part and the ability of the metal to absorb the heat), while not exceeding the maximum internal temperature rating of about 1600° F. or 871° C. Because the high density cartridge heaters are compacted, the dense nature of the cartridges also tend to be relatively robust against vibrational stress.

Cartridge heaters rated for low watt density applications (low density cartridges, also known as standard cartridges) are capable of producing only low watt density values at lower heated material temperatures, before exceeding the internal temperature rating of the heater. Compared to the high density cartridge, the low density cartridges construction does not transfer heat as efficiently from the internal element wire to the cartridge sheath, which limits its watt density range from 0 to about 50 watts per square inch of surface area (depending on the fit of the heater in the part and the ability of the metal to absorb the heat), while not exceeding the maximum internal temperature rating of about 1500° F. or about 816° C. A consistent relationship exists between high and low density cartridge watt density capabilities regardless of the object or material to be heated. The difference in performance between the two is directly dependent on the efficiency of heat transfer from the element, through the electrical insulation, to the sheath. The resulting temperature difference between the element and the sheath is called At.

A typical high density cartridge heating element comprises a coiled resistance wire extending coaxially along the length of an elongate metal sheath, usually wound about a ceramic core and attached to conductor pins. An insulating filler having an optimum combination of relatively high thermal conductivity and relatively low electrical conductivity is used to fill the space between the coil and the inner wall of the sheath. Granulated magnesium oxide is known to be particularly suitable for the purposes of serving as the insulating filler material. Other granular ceramic insulation materials include silicon dioxide, aluminum oxide and boron nitride. The granulated magnesium oxide is introduced into the sheath after the resistance wire, conductor pin and core assembly is positioned in the metal sheath.

Thereafter, the sheath is sealed, and the sheath is subjected to compression forces, for example, by a swaging or rolling process, to compact the sheath, the core and the insulating material to into a cylindrical, dense heating element to improve its dielectric and thermal conductive properties. When finished, the high density cartridge is compacted to substantially its theoretical density. Typically, the density of a magnesium oxide filled material will increase from about 2.4 to 2.5 g/cm³ to about 3.0 to 3.1 g/cm³. Although the density of the materials may vary, the magnitude of density increase will be substantially similar to that found in magnesium oxide. It is believed that useful high density cartridges are made with greater than or equal to about 80% of theoretical density.

Unfortunately, cylindrical cartridges are difficult to incorporate into heated tools or assemblies. Efforts to fit compacted cylindrical cartridges into heated tools are often limited by the cylindrical nature of the cartridge. Cylindrical cartridges must generally be inserted into drilled or reamed holes. However, the drilled or reamed holes required to incorporate cylindrical cartridge heaters must be very precisely made to accommodate the cylinder. Due to small imperfections along the surface of the cylindrical cartridge, longer cylinders are harder to fit than shorter cylinders. In addition, when heated, the cylindrical cartridges tend to freeze in the holes, and cannot be replaced without damaging the tool. Further, although milled slots can be made for cylindrical heaters, the degree of precision (and therefore cost) required to maintain a reasonable fit to block around the entire heater, renders uneconomical the use of slots for cylindrical cartridges to all but the most specialized applications. Until now, when one needs to incorporate a high density heater in a heated assembly, one must contend with the attendant drawbacks in fitting cylindrical cartridges in the tools.

The typical standard cartridge does not undergo the compacting or swaging process. Therefore, in addition to being limited to lower temperature applications, the standard cartridges is also more susceptible to vibrational stress than compacted cartridges. However, the standard temperature cartridges can be formed from a variety of rectangular cross-sectional shapes, such as square cross-sections, which provides greater surface area contact with adjacent tools or assemblies. Therefore, square cartridges can be inserted into milled slots in heated tools, permitting the fitting of greater lengths of cartridges within the heated tools. It would be desirable to have a compacted rectangular cartridge that has both the advantages of the rectangular shape, and the heat and vibrational tolerance of the compacted cartridge.

Heretofore, attempts to reliably produce high-voltage rectangular cartridge heaters have not been successful. A combination of factors tends to lead to problems with dieletric breakdown and current leakage problems. In some cases, operating parameters such as dielectric strength and current leakage must be kept within predetermined limits in order for the cartridge to meet certain industry standards, such as those established by Underwriters' Laboratories. It is apparent that current cartridge filling and compacting equipment, and manufacturing technology cannot consistently keep pace with tight manufacturing tolerances.

### SUMMARY OF THE INVENTION

The present invention provides a swaged cartridge heating element or heater with a flat side. In another embodiment, the invention provides a substantially polygonal cross-section (e.g. rectangular, square, etc.). The present invention also provides a method for making a swaged cartridge having a substantially polygonal cross-section. In one embodiment, the cross-section is a substantially square cross-section. In another embodiment the square or rectangular cartridges are further formed or bent into a variety of heating configurations.

Rectangular compacted heaters are generally more versatile, and can be adapted to most solid, liquid, gas and radiant heat applications. The rectangular cross-section provides for more variation in terminal styles and locations. In tool heating applications, rectangular cartridges are easier to install, and easier to remove for maintenance and cleaning. The square configuration provides a larger surface area, and allows the total wattage for a given application to be increased by up to about 25% over cylindrical cartridges. Smaller square cartridge can be made with sufficiently high resistance to operate on standard voltage. Moreover, a variety of sizes are available, as well as any number of square and rectangular cross-sections. Other cross-sectional embodiments may include triangular cross-sections, hexagonal cross-sections and octagonal cross-sections. Another potential cross-section is that of a half-circle.

### BRIEF DESCRIPTION OF THE FIGURES

FIG. 1 is a partial cut-out view of a cartridge heating element having a square cross-section according to the invention.

FIG. 2 provides a number of views to illustrate the orientation of the pins in relation to the bend plane.

FIG. 3 provides a cross-sectional view of two square cartridges in a heated tool.

FIG. 4 illustrates a number of differing lead configurations for polygonal cartridges.

FIG. 5 schematically illustrates different heating options for the polygonal cartridges.

FIG. 6 provides a cutout schematic along the length of rectangular cartridges illustrating different thermal control options.

FIG. 7 illustrates a different rectangular cartridges constructions, including those that are formed into bent shapes.

FIG. 8 illustrates a heated tool which incorporates the polygonal compacted cartridge according to the invention.

FIG. 9 illustrates a heated plate which incorporates the polygonal compacted cartridge according to the invention.

### DETAILED DESCRIPTION

The invention is described by the following examples. It should be recognized that variations based on the inventive features disclosed herein are within the skill of the ordinary artisan, and that the scope of the invention should not be limited by the examples. To properly determine the scope of the invention, an interested party should consider the claims herein, and any equivalent thereof. In addition, all citations herein are incorporated by reference.

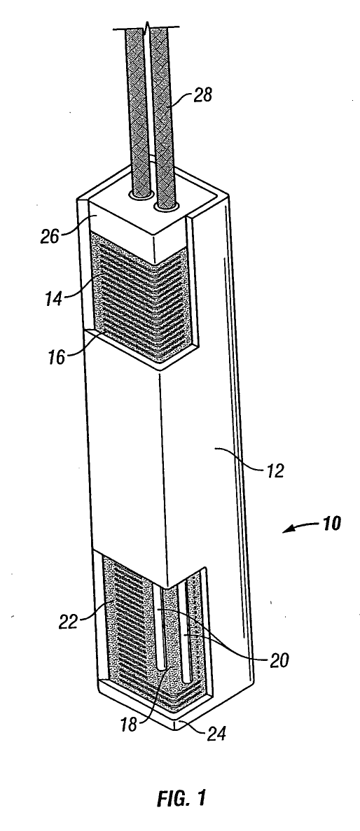

FIG. 1 illustrates an embodiment of a swaged, polygonal cartridge heating element 10 in accordance with the invention. In the present embodiment, the cross-section is a square with sections of the outer metal sheath 12 cut out to show the interior core assembly 14. Cote assembly 14 comprises resistance wire 16 precision wound on a high purity ceramic core 18, a portion of which is also cut out to illustrate the internal pins 20. Resistance wire 16 are in intimate contact with internal pins 20 that, when swaged, provide an integral bond for optimal connection life. Other embodiments include elements wires that are wrapped around, then welded to the pin, or elements that are attached to an intermediate connection fitting, such as a tube or ribbon, which is then swaged or welded to the conductor pin. Such modifications may be useful to reinforce the connection.

Internal pins 20 provide the electrical terminals to provide electricity to the resistance wires. In an embodiment, they are led out of the cartridge through a ceramic end cap 26 to be attached to electrical leads. In another embodiment they are kept within the sheath, and electrical leads are attached to the conducting pins within the sheath. In an further embodiment, the leads are covered by lead wire insulation 28. Examples of other lead types include flexible leads, braid protected leads, armor protected leads. In an embodiment, the lead wire insulation is rated for about 842° F. or 450° C. Numerous terminals are used to power the cartridges, including post terminals, spade terminals, plug terminals and box terminals. In a preferred embodiment, the internal pins are received in axial slots or holes in the ceramic core and extend through substantially the length of the cartridge.

Before it is compacted, the assembly to be compacted is called a start. The start comprises the core assembly, the fillers, the sheath, and means to seal the contents within the sheath. During manufacture, the core assembly is precisely located in the sheath according to the application of the cartridge heater. Generally, the core assembly is centered in the sheath to provide optimal heat uniformity about the cartridge periphery. Centering spacers (not shown) are well-known in the art. For the purposes of making polygonal cartridges, the spacers are bigger than those used for positioning the internal assembly in ordinary cylindrical compacted cartridges. For standard sized cartridges the spacers are bigger by about 0.010 to about 0.040 inches, depending on cartridge size. However, for bigger cartridges, determining a concomitant increase in spacer size would be well within the skill of the ordinary artisan.

To compact a round start into a polygon cartridge, the insulation layer in the start must be thicker than that used to swage a round start into a round cartridge. The larger spacer provides the spacing needed to provide the thicker insulation layer. The core assembly may also be positioned off center to improve the dielectric of the cartridge or to particularly direct heating to a side. A square assembly configuration allows the core assembly to be positioned close to the outer sheath. Voids are filled with known fillers such as magnesium oxide ceramic insulation 22. As indicated above, other fillers are also known. Because the spacers are bigger, more filler is used than for cylindrical cartridges.

In one embodiment, an end of the metal sheath is capped by a welded end seal-24, while the other end is sealed by a temporary sealant material, made from plastic, such as hot melt glue or plastic disc. Once the ends are sealed, the cartridge is compacted to form the swaged polygonal cartridges, including rectangular and square swaged cartridges. After completion of any finishing and forming operation, the lead system is attached and a permanent protective end seal such as a ceramic cap 26, a Teflon cap, electrical cement potting material or silicon potting material is applied or installed.

In another embodiment, the lead end seal consists of a permanent lead seal assembled directly on pins or leads at the intended lead end of the element assembly. The permanent seal can comprise mica, lava, teflon or other materials which will seal the lead end, and withstand the deformation which occurs during the compacting process. In this case, the intended lead end of the metal sheath must be provided with a stop against which the assembly can be seated as it is inserted into the disc end of the metal sheath. This stop is typically formed by rolling a groove into the metal sheath at the intended lead end of the tube, or by rolling over the lead end of the tube to reduce the sheath opening at the lead end, and to form a step on the inside diameter of the tube to provide a stop for the assembly. The assembly is then installed through the disc end of the metal sheath to seat against the stop. When the filling end is accomplished, the disc end of the metal sheath is capped by a welded end seal 24. As previously discussed, once the ends are sealed, the cartridge is compacted to form the swaged cartridges having at least one flat side, including polygonal cartridges that includes rectangular and square cartridges. After any additional finishing or forming operation is completed, lead protection systems and/or other protective end seals such as a ceramic cap, a teflon cap, electrical cement potting material or silicone potting material can be applied or installed.

The cartridges are made from materials that are well-known in the art. Depending on the applications, the sheath may comprise any number of metals that are well-known in the art. Some embodiments use stainless steel (e.g. 304 or 430 stainless steel). Others use iron based alloys such as INCOLOY® (also known as Alloy 800; about 39.5% iron, 30-35% nickel, 19-23% chromium and trace elements) or nickel based alloys such as INCONEL® (about 76% nickel, 15.5% chromium, 8% iron and trace elements) (both from INCO Alloys Int'l, Toronto, Ontario, Canada).

Although the metal sheath may start with any cross-section, round cross-sectional sheaths are preferred because they are particularly useful and versatile. For example, it is possible to make both square and rectangular cartridges from the same starting materials (e.g. 1/4 inch square cartridges and 3/16 by 5/16 rectangular cartridges are made from the same starts). For the rectangular cartridges, width to thickness ratios are up to about 1.78, preferably about 1.5 to about 1.78, can be achieved from round starts. Higher ratio rectangles are produced from flattened round starts.

The sheath wall used in conjunction with the present invention generally requires a greater thickness that than of ordinary compacted cylindrical cartridges. The final size of the cartridge dictates the extent that the sheath wall must be thicker than that normally used for cylindrical cartridges. Current specifications indicate the following final square cartridges size to corresponding increases in sheath wall thickness: ¼=about 0.007 inch; 5/16=about 0.010 inch; ⅜=about 0.011 inch, ½=about 0.011 inch; ⅝=about 0.12 inch. The trend is for the added thickness to increase as the size of the final polygonal cross-section increases. As for the spacers, this determination should be well within the skill of the ordinary artisan.

Various metals are available as resistance wire including nickel-chromium wires. The ceramic core about which the resistance wire is wound is formed from well-known ceramic materials, including high quality magnesium oxide. The ceramic core can have a variety of cross-sections. In general, round cores work well, even when used to make square cartridges. The hardness of the ceramic core is generally less than that used for ordinary compacted cylindrical cartridges. It has been shown that use of a 10,600 psi modulus of rupture core resulted in open element cores that were unacceptable. This indicates that using normal hard ceramic cores would result in a high percentage of open elements. In an embodiment of the present invention, the core used in the compacted polygonal cartridges has a modulus of below about 10,600 psi. In another embodiment, the core has a modulus below about 9000 psi. In a further embodiment, the psi modulus of rupture for the core is about 3000 to about 7000.

In another embodiment, the start comprises a standard N-termination nickel lead wires connected to solid nickel conductors. Fiberglass sleeves shield the wires which are fed through a ceramic end cap, and a swaged-in lava plug. The solid nickel conductors are connected to Ni—Cr resistance wires that are wound about a high purity MgO core, and positioned in the alloy sheath, with MgO as filler. For a rectangular cartridge, the conductor pins should be oriented such that the centerline of the pins are aligned along the width of the rectangle, in order to assure good clearance between the pins and the winding. To accommodate the modified tubing and ceramic sizes that are different from standard cylindrical compacted cartridges, a vibration filling machine that has been adapted to accommodate the new sizes of tubing and ceramic is used.

Once assembled, the start is compacted into a polygonal cross-section having a desired final density. Preferably, the start is compacted into near theoretical density. In one embodiment, the compacted cartridge has a square cross-section. In another embodiment, the compacted cartridge has a rectangular cross-section. Preferably, the starts are compacted in a simultaneous blow swaging machine. Numerous swagers are available in the art for swaging a polygonal cartridge (Stationary Spindle Swaging by Abbey Etna of Perryburg, Ohio; Models 211SS and 323SS from The Torrington Company of Waterbury, Conn.). The dies used to compact the cartridges have a shallow entrance angle. In an embodiment, the angle is less than about 3 degrees for a square cartridge. In another embodiment, the angle is about 1.5 to 5 degrees per side. In a preferred embodiment, the angle is about 3 to 5 degrees per side. In another embodiment, the angle is between about 2 degrees and about 3 degrees. In the case of rectangular cartridges, the die angle is normally about 3 to 4 degrees to accommodate the entry of the start diameter into the die opening. The swaging integrally bonds the resistor wire to the lead conductor, and compacts the internal ceramic core and ceramic insulation to a variety of densities, including near theoretical density. The densely compacted assembly provides the optimum heat transfer and insulation dielectric that provides excellent heater performance and reliability, while maximizing resistance to vibration, shock and physical abuse.

One surprising embodiment of the compacted rectangular cartridge according to the invention is that it is possible to form or bend the rectangular cartridge anywhere along its length, without a high rejection rate from damage to internal electrical contacts, conductor pins, element wires or insulation wall integrity. In other words, the cartridge can be bent to form numerous special configurations for a broad range of tooling and process applications. Moreover, two or more cartridges can be attached to form different configurations, such as right angle cartridge, or simultaneously formed into multi-turn coil styles. This provides angular configurations and coils with different combinations of cross-sectional areas, lengths, and turn spacings that would push the length of a straight heater to the excesses of practical manufacturing limits. At the same time, the formed cartridge still allows all lead exits to be located in the same area of the coil length. The capability to bend the square cartridge allows the heater to be configured to heat larger areas. This allows the user to minimize the number of required individual heaters with their concomitant lead terminations. Too many heaters may require customized terminals to accommodate all of the lead terminations. This substantially reduces wiring complexity costs.

By contrast, compacted cylindrical cartridges have been formed only in the cold areas. Moreover, the contacts may twist during the compacting step of cylindrical cartridges. When the contacts are twisted, bending cylindrical cartridges run the risk of pushing the contacts together to form a short. As a result, all heater manufacturers proscribe the bending of compacted cylindrical heaters. It is feared that the bending process may damaging the dielectric properties and the internal electrical connections by differential movement and stretching of the components of the round cartridge. Further, any attempt to bend standard cartridges would fracture the ceramic core, damage the wires and destroy the dielectric properties, because such cartridges are made of a tube which contains a ceramic core with wiring strung through them, and loosely filled with granular ceramic powder.

Another surprising feature of the compacted cartridge having at least one flat side, is that the wire on the flat side is thinner after the compacting process than the wire at the corners. This is contrasted with cylindrical compacted cartridges, in which the diameter of the resistance wire uniformly increases because the diameter of the core uniformly decreases. As a consequence, when the cylindrical cartridge undergoes compaction the resistance of its resistance wire uniformly decreases. This effect is demonstrated as follows. In cylindrical cartridges, after compaction, starting resistance is divided by a factor of 1.3 for a 1/4 inch cartridge; 1.3 for a 5/16 inch cartridge; 1.28 for a 3/8 inch cartridge, 1.27 for a ½ inch cartridge and 1.38 for a 5/8 inch cartridge. By contrast, in rectangular cartridges, after compaction, starting resistance is divided by a factor of 1.18 for a 3/16 by 5/16 inch cartridge (equivalent to 1/4 inch); 1.22 for a ¼ by 3/8 inch cartridge (equivalent to 5/16); 1.09 for a 9/32 by ½ inch cartridge (equivalent to ⅜). The resistance factor for square cartridges are similar to that of cylindrical cartridges. However, it is believed that the higher resistance at the sides are offset by the lower resistance at the corners for the square cartridges, and that this would not adversely affect properties which provide more heat to the sides than the corners.

Another advantage of this phenomenon is improved wire loading (watts per square inch of actual element surface). The square and rectangular compacted cartridge heater manufacturing provides a higher percentage of wire coverage in proximity to the cartridge surface. This reduces the watts per square inch of actual element surface required to transfer heat through the ceramic insulation, the sheath and finally to the heated material. When beginning with a round start, the winding of wire can be tighter and at a closer pitch than on strip material. However, in the swaging operation, the wires elongate (typically between about 7 to 10%) and are separated by the ceramic, so that such tight turns are sufficient to prevent shorting. Accordingly, there is a higher percentage of wire coverage on the sides of the rectangular compacted cartridge than that of other types of heaters.

For the compacted cartridge having at least one flat side, the difference between the resistance wire thickness at the sides versus the corners has practical applications. Because resistance for thinner wire is greater than that for the thicker wire, the thinner wire will generate more heat than the thicker wire. Since it is the flat side of the cartridge that is used to contact the material to be heated, the ability to generate more heat on the flat side is a desirable feature. Moreover, because the corners of the cartridge often do not contact the material to be heated (sometimes due to the chamfered corners), those areas may overheat and damage the cartridge. Having thicker wire in the corners decreases the amount of heat generated at the corners, and thereby prolong the life of the cartridge. This feature is particularly useful for rectangular cartridges in which the wider sides are used for heating, while the thinner sides are not. Having two corners closer to each other will decrease the heat generated on the thinner sides, while the thicker sides can generate more heat for the desired application.

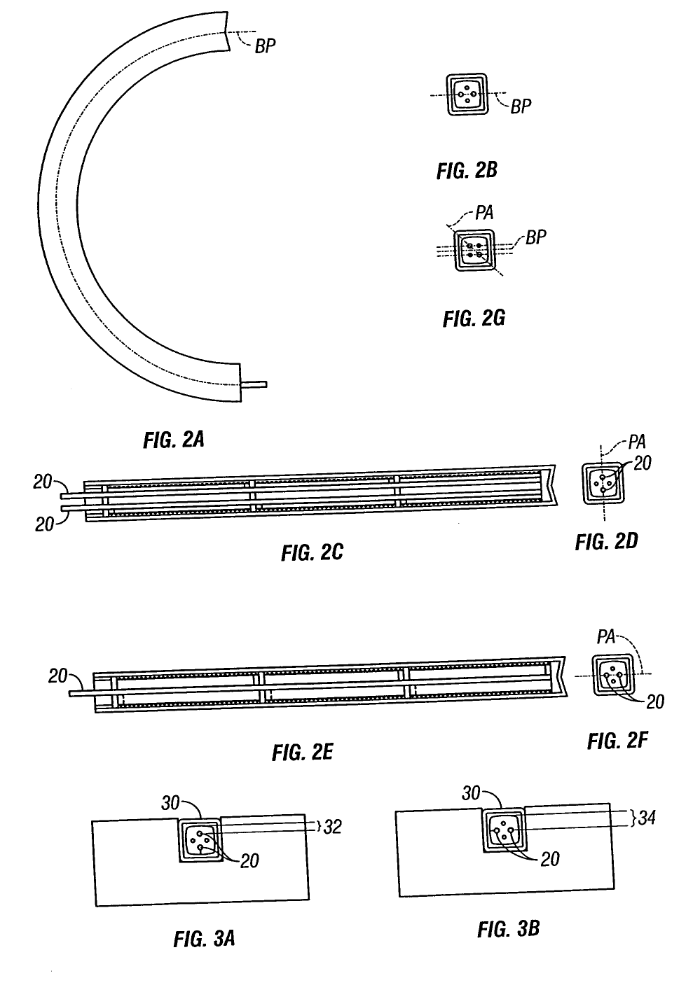

FIG. 2 illustrates a variety of embodiments of the positioning of the internal pins relative to a bend plane, BP. FIG. 2a provides a side view of a formed square cartridge having a bend plane BP that horizontally bisects the cartridge along the central axis. Bend plane BP is shown in the cross-sectional view in FIG. 2b. FIGS. 2c and 2d illustrate the case where the lead pin axis, PA, is perpendicular to the bend plane, while FIGS. 2e and 2f, illustrate the case where the lead pin axis is the same as the bend plane. FIG. 2g illustrates a cross-section wherein the pin axis crosses the bend plane at an angle. The preferred pin position is found in FIGS. 2e and 2f. The bending of the cartridge according to the other angles is accomplished by maintaining the element to pin connection. Note that FIGS. 2b, d, f and g also illustrate chamfered edges for the rectangular cross-sections in particular, and for polygonal cross-sections in general.

The internal pin conductors of the rectangular cartridge heaters can be oriented axially in relation to a flat side of the heater and, with the addition of a small cold section in an intended lead, exit anywhere along the cartridge length. This allows access holes to be machined into the surface of the heater in the desired location, so that ceramic can be removed to expose the pins, and power leads can be attached to the exposed pins. Note that the axial position of the pins relative to the heater surface can be maintained throughout the length of the heater. FIG. 3 provides a cross-sectional view of two square cartridges in a tool to illustrate the pin location in which one surface has a higher temperature than the opposing surface. Surface 30 has a higher temperature than the other three surfaces, due to an absence of conductive heat transfer. In FIG. 3a, the pins 20 are oriented perpendicularly to surface 30 so that gap 32 is smaller than a corresponding gap 34 in FIG. 3b, where the pins are oriented on a parallel axis to surface 30. The latter configuration keeps the heater from overheating, and reduces the possibility of contact and insulation failure.

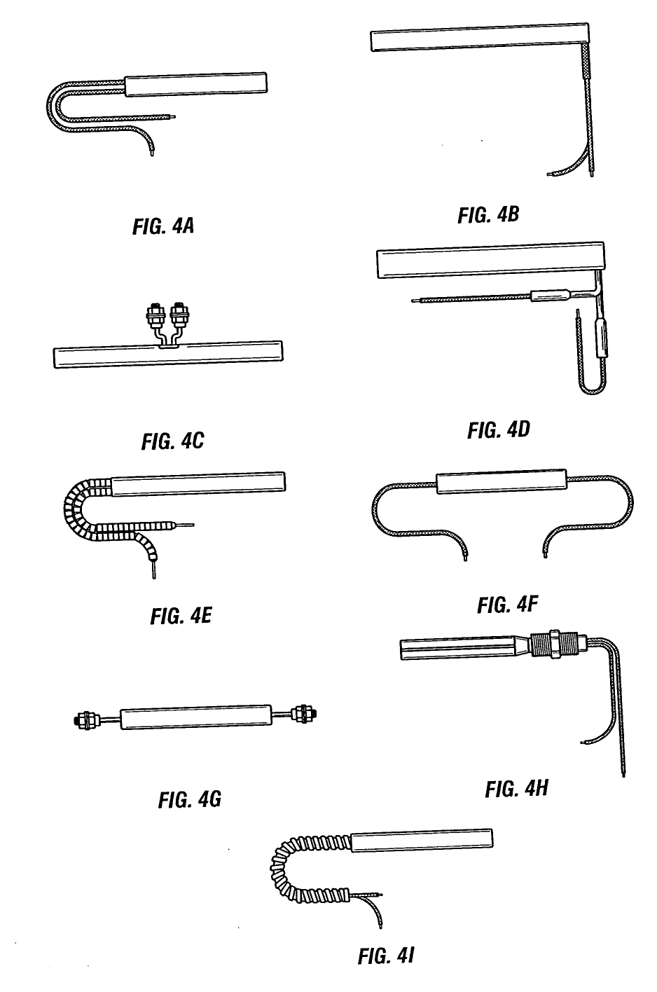

The ability to orient the internal lead pins and contacts to place them in the areas of lowest temperature is especially useful where the cartridge features differential heat transfer for different areas or surfaces. This extends the contact life and increases the insulation value between internal lead conductors to improve performance and reliability. FIG. 4 illustrates a variety of lead options that are known in the art which may be applied to the swaged polygonal cartridges. In addition to standard leads, FIGS. 4f and 4g illustrates double ended lead options, while FIG. 4c illustrates a center lead option. FIG. 4e illustrates an armored lead option.

Because the polygonal compacted cartridges can be bent into many shapes and can accommodate many different lead options, they, and in particular the rectangular cartridges, are suitable for a wide range of heating applications. The rectangular cartridge overcomes many of the shortcomings and limitations inherent in other types of heating elements. Moreover, the square cartridge heating element can be configured to provide the function of many other types of heating elements (cross-functionality). Heretofore, many different applications require different heater styles such as tubular, strip, band, ring, plate, cable and/or cast heaters. Many of the features of these styles can be implemented in the compacted rectangular cartridge.

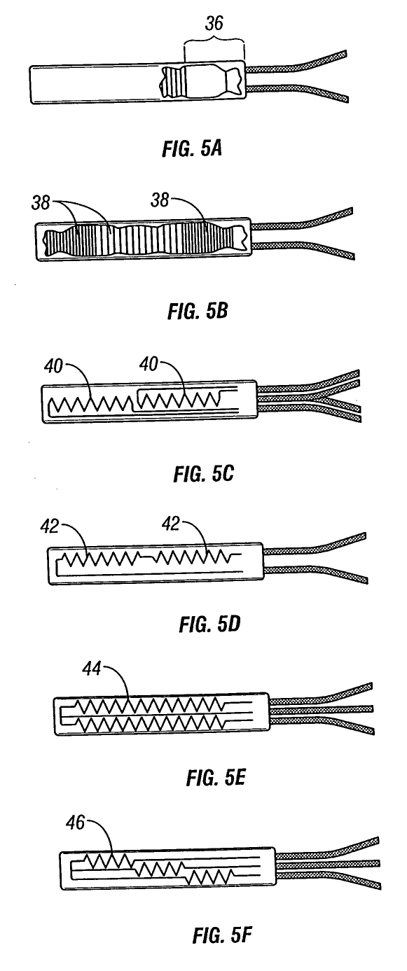

In addition, the compacted rectangular cartridges can also accommodate many different heating element styles such as distributed wattage, multiple independent heat zones, internal temperature sensors and multiple core units in parallel or in series. FIG. 5 schematically illustrates a variety of heating options for the rectangular cartridges. Examples include cartridges having a cold section 36 (FIG. 5a), distributed wattage 38 (FIG. 5b), independent heat zones 40 (FIG. 5c), dual element single circuit 42 (FIG. 5d), series parallel dual voltage element 44 (FIG. 5e), and three phase wye element 46 (FIG. 5f).

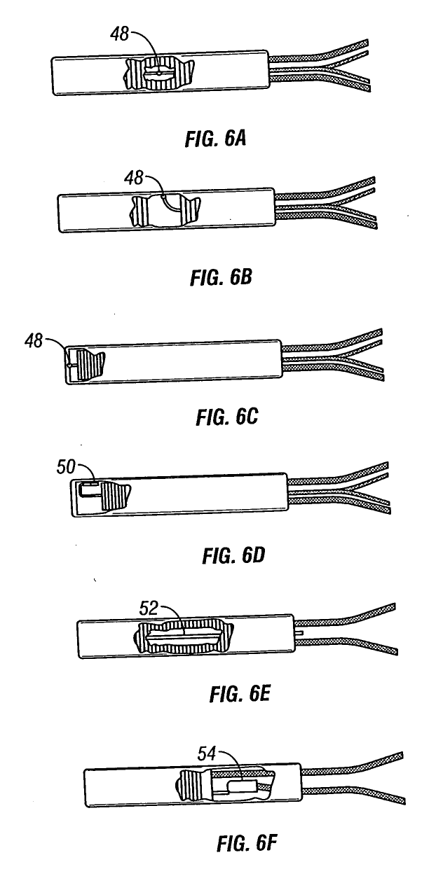

FIG. 6 illustrates a number of thermal control options for the square cartridges. The options include internal and external thermocouple junctions 48, RTD element 50 (resistance temperature detector, where a metal alloy wire or film, for example comprising platinum, wound or deposited on ceramic that changes resistance with temperature, so that temperature may be measured by measuring the resistance), thermowell 52 and thermostat 54. Semi-conductor thermistors may perform the same function as the RTD elements.

Without being limited by any theory, the ability to bend or form a compacted polygonal cartridge without disturbing the integrity and quality of the internal element to pin connections and insulation dielectric appears to arise by the uniform application of force against the periphery of the polygon that forces the flat surfaces, the insulation material, the element winding, the element contacts and the pins to compress at a more uniform rate throughout the cross-section during the bending process. The more uniform movement of the internal element assembly reduces differential movement between the components of the element to pin connections that would damage or break the connection. The uniform movement also appears to minimize variations in insulation wall thickness across the width of the cartridge cross-section in the external portion of the bend area during bending. In formed configurations that require an extremely tight bend radius, the internal lead conductors and element connections can be axially oriented parallel to the desired bend plane. This allows the formations of small radii bends without damaging the resistor wire to pin connection.

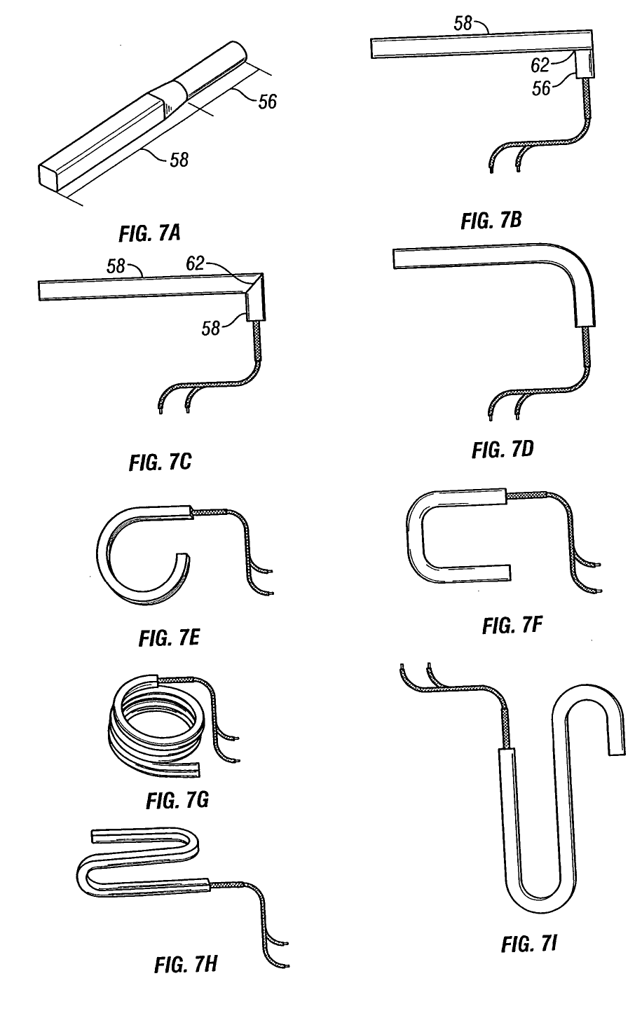

FIG. 7 illustrates a number of construction options in which the square cartridge has been formed or bent. Examples include having a round lead end length 56 coaxially attached to a square length 58 having a tapered transition 60 (FIG. 7a), having two square lengths 58 attached at a right angle by a weld 62 (FIG. 7c), having a square length 58 attached to a round extension length 56 at a right angle by weld 62 (FIG. 7b), and a rounded 90° sheath (FIG. 7d). Additional examples include square cartridges that are bent into a C-shape (FIG. 7e), a U-shape (FIG. 7f), a coil (FIG. 7g), a N-shaped figure in two planes (FIG. 7h), and a S-shape (FIG. 7i).

The ability to factory or field form square and rectangular cartridges into more complex configurations, makes them well-suited for a variety of solid, liquid and gas heating applications. Compound multi-plane, multi-axis, spiral and multi-turn style bends can be provided at any desired location along the entire cartridge length without damaging the internal components and element connections. All bending operations are accomplished with standard bending equipment (e.g. Hand Bender from Di-Acro, Incorporated of Canton, Ohio). The ability to form the new square cartridge further simplifies heating of odd tooling shapes and increases the heater versatility for both small and large tooling components. The rectangular cartridges and the slot mounting method is readily combined with machined plates and shapes of aluminum, brass, bronze or other alloys to create a quality substitute for most plate and cast heater configurations. This approach improves heating efficiency, and allows heater and lead maintenance and repair with a quicker turn around time.

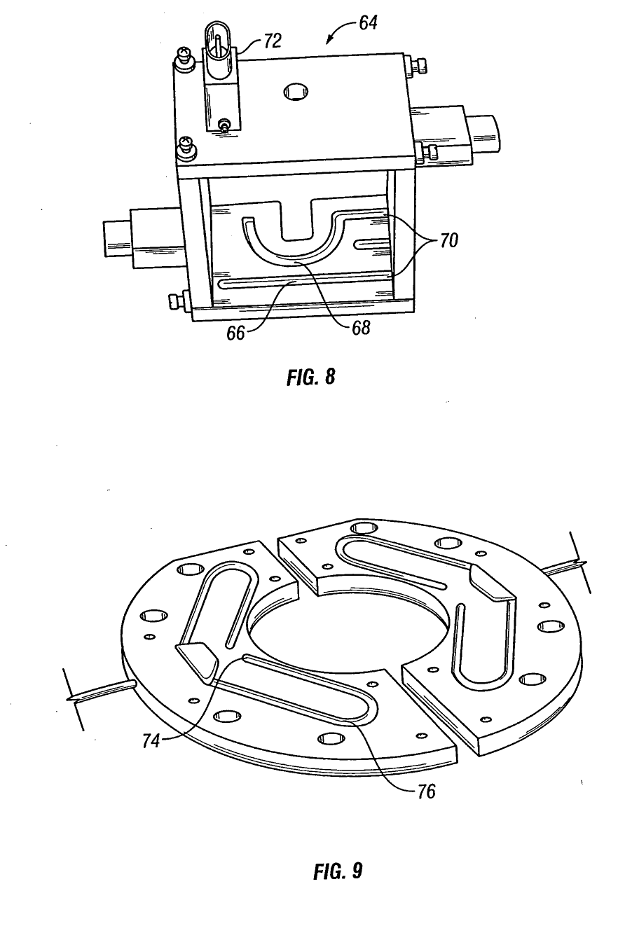

The rectangular cartridges are particularly useful for incorporation into heated tools or assemblies. The traditional cylindrical cartridge approach to tool heating requires a costly, time consuming deep hole drilling of the tool to install the cartridge. The compacted polygonal cartridge, can take advantage of surface milled polygonal slot mounted systems. Rectangular compacted cartridges are particularly useful in milled rectangular slots. This approach provides a close fit between the cartridge and tooling to maximize the heat transfer and performance while providing easier removal for maintenance. In FIG. 8, a heated tool 64 is shown with a first slot 66 to receive a linear compacted cartridge heater (not shown), and a second slot 68 to receive a curved compacted cartridge heater (not shown). Further, in FIG. 8, lead channels 70 provided during the slot machining process protects the heater lower leads while allowing routing of the leads to connectors 72 or terminal strips at any desired location on the tool. In another case, the square cartridge was incorporated into a bronze casting by machining the casting. Previous efforts at such incorporation required sand molding, which is much less economical. Another example of incorporating the compacted polygonal cartridge heater according to the invention in a heated tool is show in FIG. 9. In this case, slots 74 are milled to closely fit compacted square cartridges that have been formed into an U shape bend 76.

While cylindrical cartridges can also be used in milled slots, the plates having such slots must have matching round slots to maintain full contact around the cylindrical heater. Attempts to use cylindrical cartridges in rectangular slots are inefficient due to the poor fit, and air gaps. Further, the slots must be aligned perfectly in order for the plates to close, and the ball radius milling cutters require a more precise, lower cutting rate than end mill type cutters. These factors increase the cost and decrease the efficiency of incorporating cylindrical cartridges into heated tools and assemblies.

The cartridges according to the present invention can also function as externally mounted band heaters to heat cylindrical objects such as molding machine nozzles, molding machines and extruder barrels. In this type of application, only the surface on the inside diameter of the cartridge contacts the apparatus to be heated. By adding appropriate grooves or steps in the surface of the cylindrical object, additional contact can be made with the polygonal cartridge heater to improve heat transfer to the cylindrical object. Addition of secondary rings or special caps provides a means for utilizing all surfaces of the cartridge to heat a cylindrical component. The formed heater can be clamped to the cylinder in a variety of ways, including strap style clamping, or fasteners attached to the heater surface designed to close the heater diameter on the cylinder.

To further illustrate the cross-functionality of the polygonal compacted cartridges, the square or rectangular cartridges can also be used as internal heating bands. In this case, the band can be pressed into a hollow cylinder, and the flat outer surface of the cartridge can be pressed into a hollow cylinder to heat the inside diameter of the cylinder. Other internal type clamping systems can also be used. In addition, the rectangular swaged cartridge may also replace strip and plate style heaters. Strip and plate style heaters are prone to contamination by water, oil and other materials, because they are usually not well sealed. In addition to the greater surface contact, and therefore heat transfer, of the rectangular cartridge, the swaged cartridge provides higher wattage, longer-life and greater application efficiency. Further, the rectangular cartridges may be replaced easily. The rectangular cartridges may also replace band and coil heaters, since they may be formed into such configurations.

The compacted rectangular cartridge is particularly useful where the final configuration requires a relatively short heater length, and a relatively large resistance to achieve the requisite combination of operating wattage and voltage. For example, rectangular cartridges of 3/16 by 5/16 and ⅛ by 1/4 inch construction, and square cartridges of ¼ by ¼ and 3/16 by 3/16 inch construction are possible. Heretofore, the only heater style that was formable was the tubular heater. However, the tubular heater requires a large element wire with a maximum resistance in the range of about 15 to 25 ohms per inch of heater length. Such wires are not conducive to small heater construction. The compacted cartridges according to the present invention are constructed with much smaller element wires, but also provide maximum element resistance in the range of about 400 to 650 ohms per linear inch of heater.

The compacted rectangular cartridge is also useful in tooling applications, where plates must be heated with multiple cartridges, and must exhibit uniform temperatures over the entire surface. In this case, the rectangular compacted cartridge according to the invention allows the number of heaters required to be reduced while maintaining satisfactory temperature uniformity over the plate surface. The reduced heaters also reduces costs, not only in the lessor number of heaters, but in the lesser amount of machining required to accommodate the heaters. Adding heaters provides the possibility of greater temperature uniformity.

In a preferred embodiment, the rectangular cartridges use single-ended lead termination systems that require the least complicated wiring and mounting systems. The formed compacted rectangular cartridge heater is extremely useful in applications requiring or preferring a single lead exit. Single-ended termination systems in square and rectangular cartridges have broad applicability, and can be easily produced on all cross-sectional sizes and configurations. Tubular heaters with single ended lead terminations are only available in a limited number of diameters with extremely limited performance capabilities. In addition, common heater options such as distributed wattage, multiple independent heat zones and internal thermocouple sensors are difficult to implement in compacted tubular heaters.

Finally, the rectangular, swaged cartridges appear to provides more consistent and reliable internal electrical contact between the pin and element wire with the material that requires heating than the round constructions. Only a small percentage of the cartridges made according to the present invention have been rejected for having an open contact. Without being limited by any theory, it appears that the simultaneous blow stationary die swaging machine, with the appropriately designed square or rectangular die, when used on the properly sized start, works less ceramic powder between the conductor pins and the element wire connection of the swaged contact. It is also believed that simultaneous polygonal swaging reduces differential elongation between conductor pin/element coil contact. This increases the practical length of cartridge that can be manufactured that operates without a single element failure.

While many compacted cartridge heater structures and methods have been described, other variations are possible, and within the scope of the invention, which should not be limited except by the appended claims.

I claim:

1. A cartridge heater that is compacted to greater than about 80% of theoretical density comprising:
a compacted core assembly comprising a ceramic core having a first conductor pin, and wherein the ceramic core is wound with an electrical heating wire and a first end of the heating wire is connected to the first conductor pin, and a second end of the heating wire is connected to a second conductor pin;
a metal sheath comprising a heat resistant alloy having substantially a rectangular cross-section enclosing the core assembly, wherein an annular space between the sheath and core assembly is substantially filled with a high temperature ceramic powder; and
a termination for each conductor pin that is capable of being connect to a electric power source.

2. The compacted cartridge heater according to claim 1, wherein the metal sheath comprises a metal selected from the group consisting of stainless steel, an iron alloy, a nickel alloy and an combination thereof.

3. The compacted cartridge heater according to claim 1, wherein the core assembly is mechanically centered within the sheath.

4. The compacted cartridge heater according to claim 1, wherein the core assembly is centered within the sheath by means of at least one centering spacer.

5. The compacted cartridge heater according to claim 1, wherein the electrical leads are attached to the conductor pins selected from the group consisting of externally, internally and a combination thereof.

6. The compacted cartridge heater according to claim 1, wherein an angular relationship between an axial orientation of the conductor pins and the flat surfaces of the heater sheath is maintained throughout the heater length.

7. The compacted cartridge heater according to claim 1, wherein an axial orientation of the conductor pins and the element wire extending from the coiled area to the contact area of the pin conductors is substantially perpendicular to a flat wall of the sheath.

8. The compacted cartridge heater according to claim 1 that is further formed to provide bends selected from the group consisting of single plane, multi-plane, multi-axis, spiral and coil bends.

9. The compacted cartridge heater according to claim 1 attached to a second compacted cartridge heater, wherein both cartridges are formed into coils.

10. The compacted cartridge heater according to claim 9 wherein the coils are selected from the group consisting of two coils with different turn spacings, two coils having different diameter, two coils having different lengths, and a combination thereof.

11. The compacted cartridge heater according to claim 1 having an axial orientation of the components of each element to pin contact in a plane that is substantially parallel to a first surface of the sheath, and wherein the compacted cartridge heater is bent along the first surface.

12. The compacted cartridge heater according to claim 1 wherein the terminations exit the cartridge at about right angle from a surface of a length of the heater.

13. The compacted cartridge heater according to claim 1 wherein the terminations exit the cartridge at a surface of a length of the cartridge that has a short cold section.

14. A compacted cartridge heater made by the process comprising:
providing a start comprising an elongated metal sheath having an elongated core assembly disposed therein with a space between the core assembly and the metal sheath,
wherein the core assembly comprises a frangible ceramic core, a resistance wire wound about the ceramic core, a first end of the resistance wire in intimate contact with a first internal pin with a first termination, and a second end of the resistance wire in intimate contact with a second internal pin with a second termination;
filling the space between the core assembly and the metal sheath with granular insulation;
sealing the ends of the metal sheath; and
compacting the start to a substantially rectangular cross-section having a desired compacted density greater than about 80% of theoretical density, wherein the compacting is selected from the group consisting of a swaging process and a rolling process.

15. The compacted cartridge heater according to claim 14, wherein the cross-sections of the metal sheath and the ceramic core are substantially round prior to compaction.

16. The compacted cartridge heater according to claim 14, wherein the compacted cartridge heater is bent into a non-linear heater.

17. The compacted cartridge heater according to claim 14, wherein the first and second terminations extend from a side of the metal sheath.

18. The compacted cartridge heater according to claim 14, wherein the core assembly further comprises a second frangible ceramic core, about which a second resistance wire is wound, and, wherein a first end of the second resistance wire is connected to a third internal pin having a third termination, and a second end of the second resistance wire is connected to a fourth internal pin having a fourth termination, and the first and second resistance wires form two independent heat zones.

19. A method for making a compacted cartridge heater having substantially a rectangular cross-section, comprising:
providing a start comprising an elongated metal sheath having a wall that is thicker than a metal sheath for a compacted cylindrical cartridge heater having an elongated core assembly disposed therein with a space between the core assembly and the metal sheath that is greater than that for a compacted cylindrical cartridge heater,
wherein the core assembly comprises a frangible ceramic core having a modulus of rupture below about 10,600 psi, a resistance wire wound about the ceramic core, a first end of the resistance wire in intimate contact with a first internal pin, and a second end of the resistance wire in intimate contact with a second internal pin;
filling the space between the core assembly and the metal sheath with granular insulation;
sealing the ends of the metal sheath; and
compacting the start to a substantially rectangular cross-section having a desired compacted density greater than about 80% of theoretical density.

20. A compacted cartridge heater having a flat outer surface comprising an elongated metal sheath enclosing an electrical heating wire connected at a first end to a first conductor pin and at a second end to a second conductor pin encased in compacted insulator material that originated from granular insulation material and a ceramic core about which the electrical heating wire was wound.

21. The compacted cartridge heater according to claim 20 having a polygonal cross-section selected from the group consisting of a triangle, a rectangle, a hexagon and an octagon.

22. The compacted cartridge heater according to claim 20 having a rectangular cross-section.

23. The compacted cartridge heater according to claim 21 wherein the each edge of the polygon is chamfered.

24. The compacted cartridge heater according to claim 22 wherein the each edge of the rectangle is chamfered.

25. The compacted cartridge heater according to claim 22 wherein the rectangular cross-section is a square.

26. The compacted cartridge heater according to claim 22 wherein the heater is formed into a coil.

27. The compacted cartridge heater according to claim 22 wherein the heater is formed to have at least one bend.

28. The compacted cartridge heater according to claim 20 wherein cartridge is a start that has been compacted to a near theoretical density.

29. The compacted cartridge heater according to claim 25 linearly attached to a round compacted cartridge heater with a tapered transition.

30. The compacted cartridge heater according to claim 20, wherein the resistance wire is wound to form a heat output circuit selected from the group having a distributed wattage, a cold section, a two-element single circuit, a series parallel dual voltage circuit and a three phase wye element circuit.

31. The compacted cartridge heater according to claim 20, wherein the core assembly further comprises a thermal control selected from the group consisting of a thermal couple, a RTD element, a thermowell and a thermostat.

32. The compacted cartridge heater according to claim 22 attached to a second compacted cartridge heater.

33. The compacted cartridge heater according to claim 32 wherein the second compacted cartridge heater is attached to form substantially a right angle.

34. The compacted cartridge heater according to claim 22 wherein the resister wire is elongated and has a smaller diameter adjacent the flat surfaces of the rectangle than the corners of the rectangle.

35. A heated tool comprising a slot milled to closely accommodate at least two sides of a rectangular compacted cartridge heater.

36. The heated tool according to claim 35 wherein the heated tool is selected from the group consisting of an aluminum plate heater; a compression mold, a mold body and an injection mold nozzle.

37. The heated tool according to claim 35 wherein the slot closely accommodates at least three sides of the rectangular compacted cartridge heater which is enclosed within the slot on a fourth side by a cover.
